(19) United States
(12) Patent Application Publication
(10) Pub. No.: US 2010/0044624 A1
(43) Pub. Date: Feb. 25, 2010

(54) ETCHANT WHICH CAN BE REMOVED WITHOUT RESIDUE

(75) Inventors: Ralph Wilken, Rastede (DE); Stefan Dieckhoff, Lilienthal (DE); Andreas Hartwig, Ritterhude (DE); Malte Kleemeier, Bremen (DE)

Correspondence Address: WEINGARTEN, SCHURGIN, GAGNEBIN & LEBOVICI LLP, TEN POST OFFICE SQUARE, BOSTON, MA, 02109, US

(73) Assignee: Fraunhofer-Gesellschaft zur Forderung der angewandten Forschung e.V., Munich (DE)

(21) Appl. No.: 11/989,980

(22) PCT Filed: Aug. 4, 2006
(86) PCT No.: PCT/EP2006/065096

§ 371 Date: May 12, 2008

(30) Foreign Application Priority Data
Aug. 4, 2005 (DE) 10 2005 037 335.6

(51) Int. Cl. C09K 13/00

(52) U.S. Cl. 252/79.1

(57) ABSTRACT

The invention relates to etchants for etching surfaces, in particular metal surfaces. The etchants are characterised in that they can be removed without residue from the respective etched surface.

The invention relates to etchants for etching surfaces, in particular metal surfaces. The etchants are characterised in that they can be removed without residue from the respective etched surface.

Surfaces are frequently released by means of etchants from locally confined unattractive or corrosion-promoting oxide films or other contamination. This applies in particular to metal and wood surfaces. For example, before being bonded together, metal surfaces must be released from impurities and oxide films in the vicinity of the intended bonding seam. Also, as regards the friction welding or friction stir welding of metals, it is advantageous before carrying out the welding step if an oxide or contamination film possibly existing on the surface of the metal to be welded is removed. In this way, oxidized components or other impurities are prevented from being incorporated into the welding seam, which could otherwise lead to reduced strength and reduced corrosion resistance. In addition, unattractive oxide films form in the vicinity of the welding seam during the welding of high-grade steels, as the result of thermal effects. These discolorations must be removed in some cases.

Acid etch compositions are used for carrying out etching steps (particularly for application in the surface treatment of high-grade steels and aluminium). Usual acids of such etch composition are nitric acid, phosphoric acid, sulphuric acid, hydrofluoric acid and oxalic acid, the acids mentioned possibly also being used in combination with hydrogen peroxide and/or urea. The etch compositions themselves contain one or more of the acids mentioned and/or at least one corresponding salt of such an acid. Likewise, it is known to use organic acids in etch compositions, for example malonic acid, fumaric acid, pyromellite acid, trimellite acid and lactic acid. Such acids are used for example in etch compositions, which are described in the Japanese publications JP 11043792 and JP 20000345363.

Depending on the type and size of the article to be etched, various etching processes are used. Small components are typically etched in dip-tanks. By contrast, in the case of larger articles to be etched, etching is usually only carried out locally. For this purpose, the surface being etched is frequently provided with an etchant by applying etch pastes, etch gels or etch foams or by spraying. To laterally limit the application of etchant, masking tape or foil is occasionally used in order to cover surface areas which are to be protected against etch attack. Such uses are known, for example, from the documents JP 3183795 and GB 1040057.

When the etchant has acted for a preset time on the surface to be etched, it is usually washed off the etched surface in a rinsing process. Substantial quantities of waste water, which in addition are heavily loaded by the etchant and must be treated accordingly, arise in this case.

The object of the present invention was to specify an etchant, for locally treating a surface which does not have the disadvantages mentioned. The etchant should be removable, especially from an etched surface, so that the cost for preferably purely mechanical cleaning of the etched surface in order to remove possible remaining traces of the etchant is minimized to a large extent. Furthermore, it should be possible to re-use the etchant, provided its etching effect has not been exhausted during the etching of a surface.

A removable etchant, containing an etch composition for etching a surface, the etchant also containing a cohesion promoter in a sufficient concentration in order to enable the etchant to be removed from an etched surface substantially without residue, is therefore specified according to the invention.

In the sense of this invention, an etchant can be removed substantially without residue if it meets the following criterion:

The etchant is removed mechanically from the etched surface of an article, for example by peeling, pulling or rubbing off. The size F of the surface previously in contact with the etchant is measured. Subsequently, the weight M₁ of the etched article is measured. Afterwards, the etched article is rinsed with distilled water until the etched surface, previously covered with the etchant, according to conventional yardsticks is free from any etching substances possibly remaining. The etched article is then dried and its weight M₂ determined after the drying process. An etchant is removable without residue if the following applies:

$$\frac{{M}_{1} - {M}_{2}}{F} \leq 1 g \text{/} {m}^{2}$$

This corresponds to a layer thickness of on average less than 1 μm with the density of the etchant layer being 1 g/cm³.

Because the etchant according to the invention can be removed substantially without residue in the sense described above, advantageously the amount of damp cleaning of the etched surface from etch composition residues, necessary when using conventional etch pastes, etch gels, etch foams or other etch compositions, is reduced. Accordingly, the means according to the invention particularly enables the quantity of necessary cleaning fluids and particularly rinse waters to be substantially reduced compared with conventional etch compositions. In the ideal case, the etchant according to the invention can be removed purely mechanically from an etched surface without rinsing needed to remove etchant residues.

The etchant according to the invention is particularly suitable for etching wood and metal surfaces, preferably for etching surfaces made of high-grade steel, aluminium and aluminium-containing alloys, iron and iron-containing alloys, copper and cupreous alloys, zinc and zinc-containing alloys, tin and tin-containing alloys, titanium and titanium-containing alloys, silver and silver-containing alloys, magnesium and magnesium-containing alloys, nickel and nickeliferous alloys. The etchant according to the invention is also suitable in preferred embodiments for etching curved surfaces.

The etchant according to the invention contains an etch composition. The etch composition in this case is that portion of the etchant, which is mainly responsible for the etching action of the etchant. The etch composition preferably contains a substance, which has an etching action on metal, or a corresponding mixture of substances; preferred substances having an etching action, are mentioned in detail below.

The etchant, apart from the etch composition, contains a cohesion promoter so that the etchant can be removed substantially without residue. The etch composition and the cohesion promoter together form an etching mass. Insofar as the etchant as well as the etching mass, thus as well as the etch composition and the (separate) cohesion promoter, contains a solid support, this is not counted among the etching mass. Advantageously, the etching mass is present as a mixture of etch composition, cohesion promoter and possibly further substances with exception of the solid support, the cohesion promoter not being counted among the etch composition.

The advantage over conventional etch compositions is achieved primarily by the use of a cohesion promoter. This causes the etchant to behave, to a large extent, as a mechanically coherent body. While, in order to remove conventional etch compositions from an etched surface firstly the surplus etch composition must be wiped off and the remaining film must be washed off afterwards at high cost for the cleaning agent, the etchant according to the invention can be removed in the manner of a coherent body without significant etchant residues remaining on the etched surface. It is possible that the etchant can be removed from the etched surface not as a coherent film, coherent foil or coherent tape as a whole, even though this is the case in preferred embodiments of the invention. While the etchant according to the invention is therefore preferably peelable, it can be rubbed or lifted off at least, so that fragments or particles of the etchant may be removed from the etched surface. When the etchant is removed from the etched surface therefore, preferably no break in cohesion within the etchant occurs but primarily a break in adhesion between the etched substrate and the etchant so that after the etchant is removed an area substantially without etchant-residue is laid bare.

The cohesion promoter is preferably a water-soluble polymer. Preferred cohesion promoters are polyvinyl alcohol, part-hydrolyzed polyvinylester and polyacrylates, cellulose derivatives, polyvinylpyrrolidone and polymethacrylates as well as polyether with acrylate groups. Particularly preferably, the spine of the water-soluble polymer used as a cohesion promoter is ether-bridge free. With such polymers it was possible to obtain cohesion promoters which can be used particularly well in respect to removable etchants.

In order to raise cohesion the person skilled in the art, on the one hand, can increase the concentration of the water-soluble polymer and its molecular weight and/or add a further water-soluble polymer. Additionally or alternatively, the person skilled in the art can also add thixotropic means, such as for example alginic acid, pyrogenic silicic acid, bentonite, kaolin or calcium fluoride. The thixotropic means in addition prevents inadvertent flowing or dripping of the etchant during application.

Additionally or alternatively, in order to raise cohesion the person skilled in the art can also take steps to reduce the adhesion of the etchant on an etched surface. For this purpose, he can preferably add to the etchant, di-, tri- and/or polyalcohols, preferably glycol, ethylene glycol, propylene glycol and/or glycerin. Preferably, the portion of adhesion-reducing substances amounts to 20-50 wt. %, related to the dry weight of the etching mass. Particularly preferred as an adhesion reducer is a multiple alcohol with a molecular weight of 90-250 gram per mol. Additionally or alternatively, ionic and/or preferably non-ionic surfactants can be used to reduce adhesion, preferably in a percentage of 5-10 wt. %, related to the dry weight of the etching mass.

In order to prevent the etchant from unintentional slipping or dropping off the surface being etched, it is preferred to adjust the adhesion of the etchant on the surface being etched to a sufficiently high degree. In order to increase the adhesive properties, the etchant preferably contains one or more organic acids, particularly preferably lactic acid and/or polyacrylic acid. Additionally or alternatively, the etchant can also contain pentose and/or hexose sugar as well as their dimers, for example saccharose, threalose, cellobiose, maltose and/or isomaltose. In this case, the adhesion of the etchant related to the cohesive force of the etchant is adjusted so that the etchant, as initially described, can be preferably peeled off but at least can be easily mechanically removed substantially without residue, for example by rubbing off.

The etchant according to the invention contains an etch composition for etching a respectively selected surface. The etch composition preferably contains a substance, which has an etching action on metal. Particularly preferably, the etch composition contains one of the abovementioned acids, in particular phosphoric acid, nitric acid, sulphuric acid and/or hydrofluoric acid. The etch composition, however, can also contain an etching base, in particular NaOH and/or KOH.

The etching action of the etchant according to the invention is at least so strong that the oxidic portion of the Al2p photo-line, measured by X-ray photoelectron spectroscopy (XPS), of an etched aluminium surface is ≦75% and the metallic portion of the Al2p photo-line is ≧25%, if an aluminium surface with an oxide film thickness of 50 nm is etched for 6 hours at ambient temperature. This corresponds to a residual oxide film thickness of 5 nm.

Preferably, the cohesion of the etchant aimed for according to the invention, is achieved by evaporating a solvent, in particular water and/or an organic solvent, which can be mixed with the etch composition. The etchant present before etching then contains an amount of water and/or preferably organic solvent of approx. 50 wt. %, related to the total weight of the etching mass, which after applying the etchant on the surface to be etched decreases, preferably by evaporation, to approx. 5-15 wt. % (again related to the total weight of the etching mass). The etchant then solidifies at least so far that it can be removed from the etched surface, for example by pulling or rubbing off.

In preferred embodiments, the etchant contains a film former for forming a cohesive etch film. The etchant—preferably altogether or at least in the form of fragments—can be removed as a film from the etched surface. The etchant is then present, at least after etching, preferably as etch film, foil or tape.

Additionally or alternatively, a preferred etchant contains polymerization means, so that polymerization is possible in order to constitute a cohesion promoter in the etchant during the etching process. The etching mass then contains suitable monomers and/or oligomers as well as hardening initiators in order to form a cohesion promoter. Particularly preferably, the etchant in this case contains one or more acrylates and/or methacrylates as monomers and/or oligomers; particularly preferred are acrylic acid, methacrylic acid, hydroxyethyl methacrylate as well as polyether with acrylate groups. The percentage of the monomer and/or oligomer preferably amounts to approx. 5-10 wt. %, related to the dry weight of the etching mass. Preferably, polymerization takes place photochemically in the presence of a photoinitiator. Preferred photoinitiators, which may be contained in the etchant or can be added to the etchant before removing the etchant from the surface to be etched, are benzyldimethylketal, 1-hydroxycyclohexylphenylketone and 2,4,6-trimethyl benzoylphenyl phosphine oxide. The etching mass contains the photoinitiator preferably in a quantity of 0.5-10 wt. %, related to the total mass of monomer or oligomer.

The etchant, in further embodiments of the invention, before etching a surface to be etched, can also be present as a liquid or paste and can be applied, for example, by brush through a tube or through spray application onto the surface to be etched. When the etchant is placed onto the surface to be etched, the cohesion of the etchant is increased automatically or by outside influence in order to achieve removability of the etchant. In preferred embodiments of the invention, however, the etchant, before etching a surface to be etched, is present as an integral body, in particular in the form of a foil or tape. The etchant is then applied, not as a liquid, but as a solid or gel-like body, onto the surface to be etched. This prevents the etchant from dispersing and permits especially clean working.

The etchant, particularly if it is provided with a solid support, before etching can also be present in a dry form. Before etching, the etchant is mixed with a solvent, preferably water. The quantity of solvent, with which the dried etchant is mixed, can be selected depending on the etching surface. A further advantage of such a dried etchant is that the etchant can be rolled or piled up without the danger of the solvent used (especially water) being squeezed out by the rolling pressure or piling weight.

Furthermore, an etchant, which comprises moisture retention means to keep the etchant moist, is preferred. The moisture retention means advantageously retards or prevents the complete drying out of the etchant. Particularly preferred moisture retention means are hygroscopic substances, for example sulphuric acid, phosphoric acid, lactic acid, glycerin, sorbitol as well as hygroscopic salts, for example magnesium chloride, aluminium chloride and calcium chloride. The percentage of the moisture retention means to be used depends on its hygroscopicity. About 40 wt. % (related to the total weight of the etching mass after the drying process in standard conditions and 50% relative air humidity) of the moisture retention means is needed, if the moisture retention means, free of additives, in standard conditions and 50% rel. air humidity has a water content in equilibrium of 15 wt. % (related to the moisture retention means free of additives). Thus, it is ensured that after the drying process in standard conditions and 50% rel. air humidity the water content of the etching mass is approx. 7 wt. % related to the etching mass dried in this way.

An etchant, which also comprises a solid support, is particularly preferred. The solid support, for example, can be a woven or non-woven tape, foil or fleece. Special embodiments of an etchant in tape form is described in the German Patent DE 86 27 072.9. The etchant advantageously in this case can be made available in a shape, which corresponds to that of the surface to be etched. In particular, the etchant can be pre-cut or pre-shaped before etching.

The etchant provided with a solid support is preferably present as a planar structure. Particularly preferred supports are polymer foils, particularly preferably, PET-, PE- and PP-foils. Particularly preferred fabric supports are polyester and/or cotton fabrics. As supports, fleeces and unwoven supports are likewise preferred, fleeces and unwoven supports based on polyester being particularly preferred.

Etchants according to the invention, in which the etch composition is placed ready made up on the solid support, are particularly preferred. These etchants avoid the need to firstly place an etch composition onto a surface to be etched and to then introduce a solid support into the etch composition. If a solid support is subsequently introduced in this way, an etch composition is easily inadvertently deformed and squeezed out, for example, on the edge of the solid support. By contrast, the ready made up etchants according to the invention permit particularly clean treatment of a surface to be etched, by avoiding the etch composition subsequently being squeezed out when the solid support is introduced. When a ready made up etchant is placed onto a surface to be etched, the danger that some of the etch composition unintentionally crosses over from the surface provided with the etchant to other surface areas, is substantially reduced or entirely avoided. As far as this description talks about an etchant according to the invention, this always means a ready made up etchant according to the invention, unless another is indicated by the context.

The ready made up etchants according to the invention, may be present in a ready to use form for etching. However, they can also be present in a pre-form, from which they can be changed by pre-treatment into the ready to use form for etching. The pre-treatment in particular may be: watering or soaking, addition of a cohesion promoter or polymerization means, in order to polymerize the cohesion promoter as described above, and addition of a plasticizer in order to increase the flexibility of the etchant. Preferably, the ready made up etchant according to the invention is present in a form, which has to be watered or soaked prior to use. Such an etchant can be particularly clean and handy to use, since it prevents unintentional loss of the etch composition from a surface area covered by the etchant or helps to avoid this.

In particularly preferred embodiments of the invention, the etchant is a ready made up etchant, possibly to be treated beforehand, in the form of an etch tape, etch foil or etch plate, an etch tape being particularly preferred. In these forms and particularly as etch tape the etchant according to the invention is easy to transport and handle. The ready made up etchant, particularly an etch tape, is preferably designed for etching a metal surface, preferably etching surfaces made of steel and high-grade steel, aluminium and aluminium-containing alloys, iron and iron-containing alloys, copper and cupreous alloys, zinc and zinc-containing alloys, tin and tin-containing alloys, titanium and titanium-containing alloys, silver and silver-containing alloys, magnesium and magnesium-containing alloys, nickel and nickeliferous alloys.

The preferred ready made up etchant according to the invention, in particular for etching a metal surface, as described above, preferably contains an adhesion reducer and in particular a percentage of 20-50 wt. % of di -, tri- and/or polyalcohols, related to the dry weight of the etching mass, in addition preferably the adhesion-reducing di-, tri- or polyalcohols being a multiple alcohol with a molecular weight of 90-250 gram per mol or a mixture of two or more of such multiple alcohols.

The solid support in the preferred embodiments of the etchant according to the invention, in particular the ready made up etchant, is provided, on the one hand, with a release agent, preferably a release lacquer based on wax or silicone. The release agent enables the etchant to be coiled up, for example, in the shape of a roll and to be easily uncoiled again from this roll without a break in cohesion of the etching mass occurring.

Furthermore, the etchant can contain corrosion-inhibiting substances, preferably in a percentage of up to 5 wt. % related to the dry weight of the etching mass, which improve the corrosion stability of a metal surface to be etched after the etching process. Preferred corrosion-inhibiting substances are chromates, phosphates, silicates, molybdates, wolframates, vanadates, zirconates, titanates, cerium compounds, triazoles, amines, morpholines and amino alcohols.

The etchant can also contain substances, and in particular acid, which lead to the formation of a conversion layer on a metal surface to be etched. For this purpose, phosphates or complex fluorides of the general formula H₂XF₆, X being silicon or a transition metal, in particular hexafluorosilicate, hexafluorotitanate and hexafluorozirconate, are preferred.

In order to produce or improve the cleaning effectiveness of the etchant according to the invention, the etchant can also contain, in the etching mass, one or more multiple alcohols as described above and/or surfactants. Since these substances can also reduce the adhesion of the etchant on a surface to be etched as described above, advantageously by using adhesion-increasing substances (likewise described above) the adhesion of the etchant according to the invention is adjusted to the desired strength.

In order, after using the etchant, to obtain a metal surface with good adhesive properties for subsequent coating processes such as bonding or painting, the etchant can contain, in the etching mass, adhesion-promoting substances such as phosphonic acid derivatives, functional silanes, phenols, carbonic acids and/or amines. Phosphonic acid derivatives, whose functional groups can react with the coating, for example the adhesive or paint, are particularly preferred.

The invention is described in detail on the basis of the examples below, the examples not limiting the subject matter of the invention.

As far as reference is made in the following examples to polyvinyl alcohol solution, a 15% solution of polyvinyl alcohol (mol. mass approximately 72,000 g/mol, Merck-Schuchart) in water is meant, the solution being made by dissolving in hot water. As far as lactic acid is mentioned in the following, an 85-90% lactic acid (Fluka) is meant. By a phosphoric acid solution, a 40% phosphoric acid solution in water is understood below. As far as reference is made below to glycerin, water-free glycerin is meant. In the examples, polyacrylic acid (mol. mass approx. 5,000 g/mol) signifies a 50% solution in water (Aldrich). Pyrogenic silicic acid in the context of the examples is, for example, Aerosil 200 supplied by Degussa.

### EXAMPLE 1

### Not According to the Invention

50 wt. parts of polyvinyl alcohol solution

40 wt. parts of lactic acid

10 wt. parts of phosphoric acid solution

The solutions are mixed and the etching mass obtained in this way, before the drying process, has a low viscosity. It is applied in a layer thickness of 1 mm onto a polystyrene foil. The etch tape is dried for 48 hours in the air flow at ambient temperature, a drying loss of approx. 50% occurring.

### EXAMPLE 2

### According to the Invention

50 wt. parts of polyvinyl alcohol solution

20 wt. parts of lactic acid

20 wt. parts of glycerin

10 wt. parts of phosphoric acid solution

The solutions are mixed and the etching mass obtained in this way, before the drying process, has a lower viscosity. It is applied in a layer thickness of 0.2 mm onto a polyester fabric tape. The etch tape is dried for 48 hours in the air flow at ambient temperature, a drying loss of approx. 50% occurring.

### EXAMPLE 3

### Not According to the Invention

33 wt. parts of polyvinyl alcohol solution

33 wt. parts of lactic acid

33 wt. parts of polyacrylic acid solution

10 wt. parts of phosphoric acid solution

The solutions are mixed and the etching mass obtained in this way, before the drying process, has a lower viscosity. It is applied in a layer thickness of 0.2 mm onto a polyester fabric tape. The etch tape is dried for 48 hours in the air flow at ambient temperature, a drying loss of approx. 50% occurring.

### EXAMPLE 4

### According to the Invention

50 wt. parts of polyvinyl alcohol solution

40 wt. parts of lactic acid

10 wt. parts of phosporic acid solution

0.15 wt. parts pyrogenic silicic acid

The solutions are mixed and the etching mass obtained in this way, before the drying process, has a lower viscosity. It is applied in a layer thickness of 0.2 mm onto a polyester fabric tape. The etch tape is dried for 48 hours in the air flow at ambient temperature, a drying loss of approx. 50% occurring.

### EXAMPLE 5

### Evaluation of the Adhesion Properties on Aluminium (AlMg3)

The etch tape from Examples 1 and 3 shows a very high tack and strong adhesion on aluminium. When the etch tape is removed about half the etching mass remains on the metal. The glycerin additive in the etch tape of Example 2 results in the improvement of removability. The adhesive film can be removed from the aluminium without visible residues. The pyrogenic silicic acid in the etch tape of Example 4 reduces the tack but not the separation resistance of the tape from the metal. The etch tape can be pulled off without residue.

### EXAMPLE 6

### Evaluation of the Etching Effect

After a 40 minute dwell time, an etching effect in the form of slight brightening of the metal is to be observed in the case of all formulations. If the etch tape is left on the metal for a day, a strong etching effect is to be recognized at the considerable white discoloration.

1. Removable etchant containing an etch composition for etching a surface, characterized in that the etchant comprises a cohesion promoter in sufficient concentration in order to enable the etchant to be removed from an etched surface substantially without residue.

2. Etchant according to claim 1, characterized in that the cohesion promoter comprises a film former for forming a cohesive etch film.

3. Etchant according to claim 1, characterized in that the cohesion promoter is a water-soluble polymer.

4. Etchant according to claim 3, characterized in that the spine of the water-soluble polymer has no ether bridges.

5. Etchant according to claim 1, furthermore comprising an adhesion reducer.

6. Etchant according to claim 5, characterized in that the adhesion reducer is a multiple alcohol with a molecular weight of 90-250 g/mol.

7. Etchant according to claim 5, characterized in that the adhesion reducer is a di-, tri- or poly-alcohol and the percentage of the adhesion reducer amounts to 20-50 wt. %, related to the dry weight of the cohesion promoter and etch composition (etching mass).

8. Etchant according to claim 1, furthermore comprising moisture retention means to keep the etch film moist.

9. Etchant according to claim 8, characterized in that the moisture retention means is lactic acid.

10. Etchant according to claim 1, furthermore comprising a solid support.

11. Etchant according to claim 10, characterized in that the solid support is selected from fabric, fleece, felt or polymer foil.

12. Etchant according to claim 1, comprising a solid support, a water-soluble polymer as a cohesion promoter in the form of a multiple alcohol with a molecular weight of 90-250 g/mol, and an adhesion reducer.

13. Use of a water-soluble polymer for producing an etchant which can be removed substantially without residue.

14. Use of a multiple alcohol with a molecular weight of 90-250 g/mol for producing an etchant which can be removed substantially without residue.

15. Etchant according to claim 2, characterized in that:
the cohesion promoter is a water-soluble polymer;
the spine of the water-soluble polymer has no ether bridges;
furthermore comprising:
an adhesion reducer is provided;
the adhesion reducer is a multiple alcohol with a molecular weight of 90-250 g/mol;
the adhesion reducer is a di-, tri- or poly-alcohol and the percentage of the adhesion reducer amounts to 20-50 wt. %, related to the dry weight of the cohesion promoter and etch composition (etching mass);
furthermore comprising:
moisture retention means to keep the etch film moist are provided;
the moisture retention means is lactic acid;
furthermore comprising:
a solid support is provided;
the solid support is selected from fabric, fleece, felt or polymer foil;
comprising:
a solid support, a water-soluble polymer as a cohesion promoter and an adhesion reducer in the form of a multiple alcohol with a molecular weight of 90-250 g/mol.
